(19) United States
(12) Patent Application Publication
(10) Pub. No.: US 2025/0049206 A1
(43) Pub. Date: Feb. 13, 2025

(54) PERSONAL CARE DEVICE WITH ILLUMINATION

(71) Applicant: KONINKLIJKE PHILIPS N.V., EINDHOVEN (NL)

(72) Inventors: Marinus Arnoldus Martinus VUGTS, Beetsterzwaag (NL); Sahar Bin HAIRALAH, Sammamish, WA (US); Richard William LIPTAK, Seattle, WA (US); Jeroen Christian NIJDAM, Eelderwolde (NL)

(21) Appl. No.: 18/723,490

(22) PCT Filed: Dec. 14, 2022
(86) PCT No.: PCT/EP2022/085736

§ 371 Date: Jun. 24, 2024

Related U.S. Application Data
(60) Provisional application No. 63/293,005, filed on Dec. 22, 2021.

(30) Foreign Application Priority Data
Apr. 26, 2022 (EP) 22170098.2

(51) Int. Cl. A46B 15/00; A46B 5/00; A46B 13/02; A61C 17/34

(52) U.S. Cl. CPC A46B 15/0036; A46B 5/0095; A46B 13/02; A61C 17/34

(57) ABSTRACT

A personal care device is proposed with a main body and attachment and wherein the attachment comprises an optical arrangement or light patterning means which receives light supplied at a light input area and processes or guides the light in such a way as to generate an illumination pattern in the attachment body which defines a 3D geometric shape or structure. The light patterning means or optical arrangement has a plurality of portions, which are each arranged to be optically activated upon supply of light to a different respective light input area, or to the same light input area but at a different light input angle, and each, upon optical activation, generating a different portion of the overall 3D illumination pattern. A set of multiple light sources are provided in the main body for respectively supplying light into different of the portions of the optical arrangement or light patterning means, and are dynamically controlled by a controller to generate a dynamically varying overall 3D illumination pattern.

### FIELD OF THE INVENTION

The present invention relates to a personal care device.

### BACKGROUND OF THE INVENTION

Within the field of personal care devices, many devices include a main body portion which houses electronic components, and one or more attachment portions which releasably couple with the main body portion. The attachment portion may be disposable. For example, a powered toothbrush includes a handle portion and a releasably coupled brush head portion.

It would be useful to be able to provide optical feedback or output to a user within the attachment portion.

By way of example, in some personal care devices, light is used as part of the personal care function, for example for an optical treatment function administered to teeth or gums. It would be useful to be able to visualize dynamically the flow of treatment light through the attachment to illustrate the optical treatment process.

It would be possible to integrate a set of light sources in the attachment, or even a digital display component. However, this is complex to power and control. It is also inefficient, since the attachment may be disposable, meaning that the electrical components would need to be thrown away with the attachment.

An alternative means of providing the optical feedback would be of advantage.

### SUMMARY OF THE INVENTION

The invention is defined by the claims.

According to examples in accordance with an aspect of the invention, there is provided a personal care device comprising:
a main device body, comprising a plurality of light sources and a controller for controlling the light sources; and
an attachment adapted to releasably couple to the main device body, wherein the attachment comprises:
   an attachment body;
   a light patterning means integral with the attachment body, comprising a plurality of light patterning portions, each light patterning portion arranged to receive light from at least one light input area of the attachment body, and to provide a respective 3D illumination pattern within the attachment body when the respective light input area is illuminated, each light patterning portion being optically supplied by a different respective light input area;
wherein at least a portion of the attachment body is formed of a light transmissible material, to permit each 3D illumination pattern to be visible to an observer at an exterior surface of the attachment body.
wherein the main device body comprises a respective light source for each of the light input areas of the attachment, each light source arranged to optically interface with a respective light input area when the attachment is coupled to the main device body, and each light source being individually controllable by the controller;
wherein the controller is adapted to implement a lighting scheme comprising dynamically controlling the light sources to produce a dynamically varying overall 3D illumination pattern within the attachment body.

Embodiments of the present invention thus propose providing a passive optical arrangement integrated in the attachment (light patterning means) which has the effect of processing light received into the device body in such a way as to generate an illumination pattern within the attachment body which defines a specific 3D geometric pattern or structure. Depending upon the location at which light is applied to the attachment body, so a different portion of the optical arrangement (light patterning means) is illuminated, leading to a different section of an overall 3D illumination pattern being illuminated. By, at the same time, providing an arrangement of lighting elements in the main device body, arranged to optically couple with different light input areas of the attachment body, so a means is provided for dynamically controlling the illumination of the different 3D illumination patterns within the attachment body, and without the need for active electronic optical components integrated in the attachment.

Thus dynamic optical visualization can be created in the attachment by illuminating the attachment dynamically from different positions and/or angles and therewith illuminating different optical structures or textures in the attachment body volume.

One advantageous area of application is oral care, and the device may be an oral care device. However, the device may alternatively be any other kind of personal care device, such as a shaver or hairdryer.

The attachment may be a personal care attachment. It may be a functional attachment. It may be for use in performing a personal care function. It may be an oral care attachment. It may be for use in performing an oral care function. For example, it may be a brush head for a toothbrush device. It may be an irrigation head for an oral irrigator. It may be a flossing head for a powered flossing device. It may be a treatment head for an optical treatment device. It may be a head for a shaver device. These exemplary options are of course non-exhaustive.

The aforementioned lighting scheme may comprise dynamically varying a selection of the light sources which is illuminated, so as to produce a dynamically varying overall 3D illumination pattern in the attachment body.

In some embodiments, the attachment may comprise at least three light patterning portions, and wherein the respective 3D illumination patterns produced by the light patterning portions, when illuminated, are spaced from one another within the attachment body along at least a first dimension. At least three illumination patterns allows for creating dynamic effects which are not possible with just two patterns. In particular, this allows for creating an illusion of motion using sequential activation of the light sources.

In this regard, in some embodiments, the lighting scheme may comprise the controller controlling the light sources so as to sequentially illuminate the light patterning portions, in order, along the at least first dimension, to thereby provide a sequentially progressing illumination pattern in the attachment body. This for example may create an illusion of motion. In the specific case for instance of a device which provides an optical treatment, this may help to provide visual feedback or guidance to a user regarding the flow of light through the attachment body.

The light patterning portions may be illuminated one at a time in a sequential pattern (i.e. the previous illumination pattern is deactivated when the next illumination pattern is activated).

In some embodiments, each respective light patterning portion may be adapted to produce a respective 3D illumination pattern comprising a plurality of discrete illumination nodes or spots, spaced from one another in at least a second dimension. The second dimension may be perpendicular to the first.

For example, the illumination nodes may produce a light output being at least brighter than that of any interconnecting sections of the light patterning portion (if any). In other words, the 3D illumination patterns each consist of a plurality of visible light spots within the device body, where these spots are apparent floating spots for example.

In some embodiments, the aforementioned first dimension may be perpendicular to the second dimension, and wherein the illumination nodes of neighboring illumination patterns are spaced from one another in both the first and second dimensions in such a way that the illumination nodes of the plurality of illumination patterns together define a set of diagonal rows, the diagonal rows spaced from one another along the second dimension.

According to this arrangement, when the respective illumination patterns are illuminated in sequence along the first dimension, this produces an optical effect of a virtual spiral pattern, dynamically indicating that the light is advancing along the length of the attachment.

The attachment may have a proximal end, for coupling to the main device body, and a distal end. The second dimension mentioned above may extend from the proximal end to the distal end. The first dimension mentioned above may extend perpendicular to the second dimension. The second dimension may correspond to a length dimension of the attachment, and the first dimension to a width dimension.

In some embodiments, the device may be adapted to perform an optical treatment function in which treatment light is emitted from at least one light output area of the attachment.

In some embodiments, a light guiding means may be provided for coupling the treatment light from at least one of the light input areas to at least one light output area of the attachment.

In some embodiments, the one or more light sources may be adapted to generate the treatment light. Alternatively, a separate set of one or more light sources may be provided for generating the treatment light. For example, the treatment light might have a different frequency spectrum. For example, the treatment light might be in the non-visible light spectrum.

With regards to the light patterning means, this may be formed by an optical configuration, structure or formation which is formed within the attachment body. The light patterning means may for example comprise an optical structure with a 3D shape, and which is adapted to scatter, deflect or reflect light which is incident upon it. In other words, it may be a light deflecting, scattering or reflecting structure.

In some examples, light patterning means for instance comprises a sub-surface material patterning in the body of the attachment having a 3D shape which, when illuminated, creates an illumination pattern which matches said 3D shape. Thus, the optical configuration is formed by a material modification of the attachment body itself.

For example, in some embodiments, the light patterning means may comprise a 3D laser engraved or etched pattern formed within the attachment body.

In one set of embodiments, the personal care device is an oral care device.

In one set of embodiments, the personal care device is powered toothbrush. The attachment in this case may be a brush head.

These and other aspects of the invention will be apparent from and elucidated with reference to the embodiment(s) described hereinafter.

### BRIEF DESCRIPTION OF THE DRAWINGS

For a better understanding of the invention, and to show more clearly how it may be carried into effect, reference will now be made, by way of example only, to the accompanying drawings, in which:

FIG. 1 illustrates an example of creating illumination patterns within transparent materials using laser etching;

FIG. 2 shows an example personal care device in accordance with one or more embodiments;

FIG. 3 shows a block diagram of components of an example personal care Fig. device;

4 shows an attachment of an example personal care device in accordance with one or more embodiments;

FIG. 5 shows a further view of an example attachment according to one or more embodiments;

FIG. 6 illustrates a dynamic lighting scheme implemented in accordance with one or more embodiments;

FIG. 7 shows components from a prototype device; and

FIG. 8 illustrates stages in the manufacture of parts of an example personal care device according to one or more embodiments.

### DETAILED DESCRIPTION OF THE EMBODIMENTS

The invention will be described with reference to the Figures.

It should be understood that the detailed description and specific examples, while indicating exemplary embodiments of the apparatus, systems and methods, are intended for purposes of illustration only and are not intended to limit the scope of the invention. These and other features, aspects, and advantages of the apparatus, systems and methods of the present invention will become better understood from the following description, appended claims, and accompanying drawings. It should be understood that the Figures are merely schematic and are not drawn to scale. It should also be understood that the same reference numerals are used throughout the Figures to indicate the same or similar parts.

The invention provides a personal care device with a main body and attachment and wherein the attachment comprises an optical arrangement or light patterning means which receives light supplied at a light input area and processes or guides the light in such a way as to generate an illumination pattern in the attachment body which defines a 3D geometric shape or structure. More particularly, the light patterning means or optical arrangement has a plurality of portions, which are each arranged to be optically activated upon supply of light to a different respective light input area, or to the same light input area but at a different light input angle, and each, upon optical activation, generating a different portion of the overall 3D illumination pattern. A set of multiple light sources are provided in the main body for respectively supplying light into different of the portions of the optical arrangement or light patterning means, and are dynamically controlled by a controller to generate a dynamically varying overall 3D illumination pattern.

By way of example, one advantageous set of embodiments uses the above optical functionality to show a dynamic behavior of a flow of light through an attachment (such as a brush head of a powered toothbrush).

The 3D illumination pattern defines a 3D structure, shape, and/or texture in an attachment body which is at least partially optically transmissible, e.g. at least partially transparent, to permit the 3D illumination pattern to be seen by an observer.

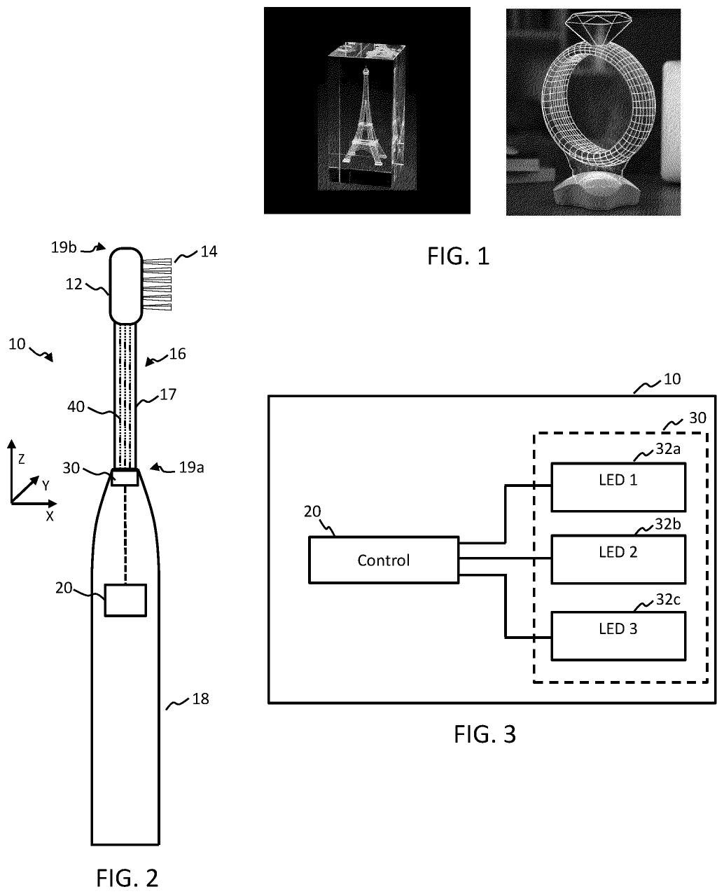

It is known from a different technical field to generate light patterns within a glass volume or polymer sheet by means of laser etching or engraving patterns within the volume of the material. When illuminated, this creates visible light structures or textures in the material. For example, when lit by ambient light or directed light, the appearance of visual structures is created. Two examples are illustrated in FIG. 1 for instance.

In particular, lasers are focused at a large array of spots in the volume of the material, the spots together defining a specific 3D shape or structure within the volume. Each laser-formed spot defines a small fracture or deformation which deflects or scatters light which is incident upon it. Thus the overall formation of spots has the effect of creating a visible pattern within the volume of the otherwise transparent material.

Embodiments of the present invention propose to apply a similar optical principle to create dynamic light shapes within the attachment of a personal care device.

An aim is to create light structures or textures in the body of the attachment, where the light structures or textures include portions at multiple different locations within the body, and preferably at multiple locations along both a length and width dimension of the attachment (the length extending from a distal end to a proximal end), i.e. in the vertical plane and horizontal plane. This can be created by for example 3D laser engraving in the attachment volume. Some or all of the rest of the attachment volume could be optically transparent or translucent. LEDs integrated in the main device body then dynamically illuminate these optical structures, creating a dynamic illumination pattern on the structures. By way of example, this could mimic movement of photon packages through the brush head in the case of an optical treatment device.

The inventive concept can be advantageously applied to any personal care device which has a main body part and an attachment part. One advantageous area of application is for oral care devices. To illustrate implementation of the concept, examples are described below in relation to a powered toothbrush device. It should be understood that the same concepts could be applied in a similar way to any other type of personal care device.

FIG. 2 shows an example personal care device in accordance with one or more embodiments. FIG. 3 shows a block diagram of electronic components comprised by the personal care device. The personal care device in this example is an oral care device. The personal care device 10 comprises a main device body 18 and an attachment 16 adapted to releasably couple to the main device body. In this particular example, the personal care device takes the form of a powered toothbrush. The attachment 16 is a brush head 16 for the toothbrush. The main body forms a handle for the device. The main body houses electrical components. The brush head comprises a platen 12 from which protrude a plurality of cleaning elements 14, e.g. bristles, for cleaning oral surfaces. Although a personal care device in the form of a toothbrush is shown, this is exemplary only and a different type of personal or oral care device may be used such as for example a brushing mouthpiece device, an oral irrigator, or a powered flossing device.

The main device body 18 comprises a lighting module 30. The lighting module comprises a plurality of light sources 32a, 32b, 32c. The main device body further comprises a controller 20 for controlling the light sources.

With regards to the attachment 16, this comprises an attachment body 17. The attachment body has a proximal end 19a and a distal end 19b. The attachment body may be understood as extending in a first (X), second (Z), and third dimension (Y), and where the second (Z) dimension is a length dimension, extending between the proximal and distal ends, and the second (X) and third (Y) dimensions are width dimensions, defining together a plane which is orthogonal to the first (X) dimension, and spanning a width of the attachment. The attachment 16 comprises a light patterning means 40 integral with the attachment body 17. This may for example comprise a laser etched optical structure.

As shown in greater detail in FIG. 4, the light patterning means 40 comprises a plurality of light patterning portions 42a, 42b, 42c, each light patterning portion arranged to couple in light from at least one light input area 52a, 52b, 52c of the body, and to provide a respective 3D illumination pattern within the attachment body when the respective light input area is illuminated. Each light patterning portion being optically supplied by a different respective light input area.

At least a portion of the attachment body 17 is formed of a light transmissible material, to permit each 3D illumination pattern to be visible to an observer at an exterior surface of the attachment body. The whole of the rest of the volume of the attachment body 17 could be formed of the light transmissible (e.g. transparent) material in some cases. In other cases, just discrete portions of the rest of the body 17 could be made light transmissible, thereby forming discrete window sections of the body, through which the 3D light patterns are visible.

With reference to FIGS. 2-4, the main device body 18 comprises at least one respective light source 32a, 32b, 32c for each of the light input areas 52a, 52b, 52c of the attachment, and wherein each light source is arranged to optically interface with a respective light input area when the attachment is coupled to the main device body. Each light source being independently controllable by the controller 20.

The controller is adapted to implement a lighting drive scheme comprising dynamically controlling the light sources in such a way as to produce a dynamically varying overall 3D illumination pattern within the attachment body.

In other words, by dynamically varying which selection of one or more of the plurality of light sources 32 are active at any one time, the resulting combined 3D illumination pattern in the attachment body can be controlled to dynamically vary. This is achieved with only passive optical components in the attachment.

Although only three light sources are shown in FIG. 3, any number of light sources may be provided. The light sources may each comprise one or more lighting elements, for example one or more LEDs. Any other type of lighting element could instead be used.

Although only the lighting module 30 and controller 20 are shown in FIG. 2 and FIG. 3, the device may typically house a number of other components associated with the oral care function, which are not shown for the sake of simplicity and brevity. For example, these might include a battery, an actuation means, a microprocessor, one or more sensor components such as inertial measurement unit, and so on.

As shown in FIG. 4, the attachment 16 in this example comprises three light patterning portions 42a, 42b, 42c. The respective 3D illumination patterns produced by the light patterning portions, when illuminated, are spaced from one another within the attachment body 17 along a first (X) dimension. The lighting module 30 comprises an arrangement of three light sources 32a, 32b, 32c in this example, one for supplying light to each light patterning portion 42a, 42b, 42c.

As illustrated, the arrangement of light sources 32 within the lighting module 30 is spatially complementary with the arrangement of light input areas 52a, 52b, 52c comprised by the attachment 16, so that when the attachment docks onto the main device body 18, each light source 32 marries up spatially and optically with a corresponding one of the light inputs areas. Thus, the light sources, when activated, each illuminate a respective one of the light input areas 52.

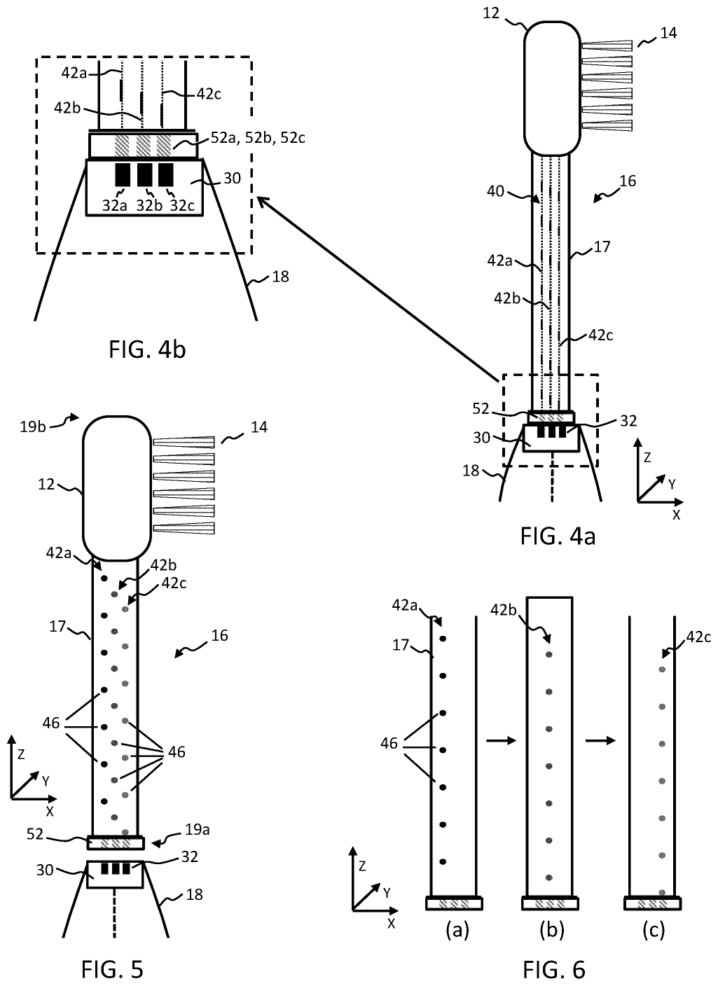

With regards to the lighting module 30, this may for instance comprise a PCB to which the one or more lighting elements forming each light source are mounted. Although in FIGS. 4 and 5, the light sources 32 and corresponding light input areas 52 are shown as being aligned in a row, and spaced only along the X dimension, the light sources could be distributed in a 2D spatial pattern, wherein the light sources are spaced from one another in both the X and Y dimensions.

As will be discussed further below, in some embodiments, the controller 20 may be adapted to control the light sources 32 so as to sequentially illuminate the light patterning portions 42a, 42b, 42c, in order, along the dimension (X) in which they are spaced, to thereby provide a sequentially progressing illumination pattern in the attachment body 17. As shown more clearly in the example of FIG. 5, each respective light patterning portion 42a, 42b, 42c may be adapted to produce a respective 3D illumination pattern comprising a plurality of discrete illumination nodes 46 (or light spots), spaced from one another in at least a second (Z) dimension. In other words, a linear array or row of light spots is formed by each light patterning portion in this example. By ‘illumination nodes’ is meant light spots or light hot-spots. These may be understood as spots which produce a light output being at least brighter than that of any interconnecting sections (if any) of the light patterning portion 42, or which are floating (without interconnecting pattern sections).

The illumination nodes 46 of neighboring illumination patterns 42a, 42b, 42c are spaced from one another in both the first (X) and second (Z) dimensions previously mentioned. In other words, each illumination pattern forms a line or row of light spots extending at least in the Z dimension, and wherein the rows formed by neighboring illumination pattern portions are spaced from one another in the X dimension and preferably also in the Z dimension. In the latter case, the result, as shown in FIG. 5, is an arrangement which is such that the illumination nodes of the three illumination patterns together define a set of diagonal rows, the diagonal rows spaced from one another along the second (Z) dimension. They are diagonal relative to the Z dimension for example.

As illustrated, in FIG. 6, if the controller 20 if adapted to control the light sources so as to sequentially illuminate the light patterning portions 42a, 42b, 42c in order along the X dimension (as mentioned above), a sequentially progressing illumination pattern is thereby generated in the attachment body 17.

This is illustrated in FIGS. 6 (a)-(c) which show sequential stages of an example cyclical illumination drive scheme. In FIG. 6 (a), the first 42a light patterning portion is illuminated, to generate the first 3D illumination pattern. In FIG. 6 (b), the second 42b light patterning portion is illuminated, to generate the second 3D illumination pattern. In FIG. 6 (c), the third 42c light patterning portion is illuminated, to generate the third 3D illumination pattern. The scheme may then return to stage (a) and repeat cyclically.

In the specific (though not essential) case shown in FIG. 5 and FIG. 6, where the illumination patterns consist of light spots which together form a series of diagonal lines (diagonal relative to the second, Z, dimension) as discussed above, this sequential drive scheme creates an optical effect which has the appearance of spiraling or helical motion.

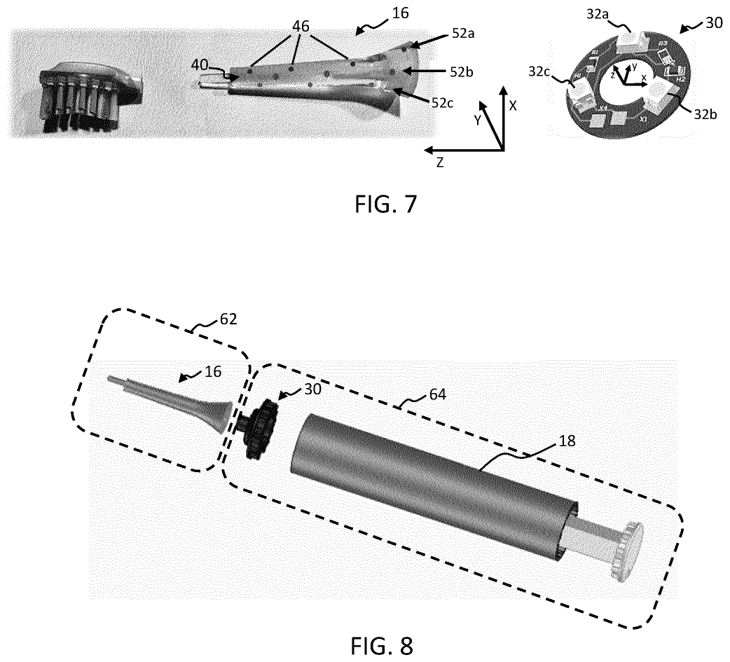

By way of further illustration, FIG. 7 shows a photograph of a prototype attachment for an example device in accordance with an embodiment of the invention. FIG. 7 also illustrates an example lighting module 30 which could be utilized in accordance with one or more embodiments of the invention. The illustrated attachment 16 in this example is in the form of a brush head for a toothbrush. The plurality of light patterning portions each define a series of light spots or nodes, as discussed above. The respective light input areas 52a, 52b, 52c for optically supplying each light patterning portion of the light patterning arrangement 40 are indicated by arrows in FIG. 7.

The illustrated lighting module 30 shown in FIG. 7 comprises a PCB to which are mounted the plurality of light sources 32a, 32b, 32c. Each light source in this example comprises a respective LED. The lighting module comprises further lighting circuit components for use in independently driving each of the LEDs.

As mentioned above, in one advantageous set of embodiments, the device may be adapted to perform an optical treatment function in which treatment light is emitted from at least one light output area of the attachment 16. The optical concept proposed hereinabove may find particularly advantageous application in such a device. In particular, it might be used to optically signal or indicate to a user the optical flow path of treatment light through the attachment, and may further indicate when the treatment light is being administered (i.e. the illumination pattern is active when treatment light is being administered).

In some examples, a light guiding means may be provided for coupling the treatment light from at least one of the light input areas 42a, 42b, 42c to at least one light output area of the attachment 16. In some example, a separate light input area may be provided for the input light.

In some examples, one or more of the previously discussed light sources 32a, 32b, 32c might be adapted to generate the treatment light. However, in other cases, a separate one or more light sources may be included in the device for this purpose.

With regards to the light patterning means, this may in general comprise an optical arrangement or structure with a 3D shape, and which is adapted to scatter, deflect or reflect light which is incident upon it. For instance, the light patterning means may comprise a 3D laser engraved pattern formed within the attachment body.

In other cases, the light patterning means comprises a sub-surface material patterning in the body of the attachment having a 3D shape which, when illuminated, creates an illumination pattern which matches said 3D shape. In other cases, the light patterning means could be formed by an arrangement of one or more optical components integrated in the body of the device.

One example method for manufacturing a device in accordance with at least one embodiment will now be outlined.

To manufacture the example device, the following method steps may be implemented.

An attachment body 17 is provided, formed of an optically transparent material, or having transparent portions. The material may be a transparent polymer.

An optical configuration, such as a light patterning means 40, is then introduced within the body 17 of the attachment. This can be achieved for example by making a modification to the material structure within the attachment body volume. For example, this could be achieved by laser etching or engraving a particular 3D pattern, texture or shape within the body volume. The introduced optical configuration or light patterning means is such that, upon supply of light to a particular one or more areas on a surface of the attachment body, a 3D illumination pattern is generated in the attachment body volume. The introduced optical configuration or light patterning means has a plurality of portions, each being illuminable by supplying light to a different light input area on the exterior surface of body. When illuminated, each portion provides a different respective 3D illumination pattern.

Instead of making a material modification to the attachment body to form the optical configuration, instead a set of one or more optical components could be integrated in the body volume. This could be performed during the fabrication of the attachment body itself.

The method further comprises providing a main device body 18 which is adapted to releasably couple with the attachment. A plurality of light sources are integrated in the housing of the main device body and arranged for optically coupling with the light input areas mentioned above when the attachment is coupled to the main body. Each light source is arranged for optically coupling with a respective one of the light input areas for activating a respective one of the light input areas.

The method also comprises providing a controller 20 in the main device body housing operatively coupled with the plurality of light sources 32. Each light source is individually controllable by the controller 20. The controller is operable to implement a lighting scheme comprising dynamically controlling the light sources to produce a dynamically varying overall 3D illumination pattern within the attachment body.

By way of further illustration, FIG. 8 shows an exploded view of a selection of components of the personal care device. The personal care device in this example is a powered toothbrush. Components in box 64 are components comprised by the main device body 18 previously referred to. The main device body forms the handle part of the toothbrush in this example. The main body comprises a body housing which houses the controller 20 (not shown in FIG. 8), and may further comprise an actuation means for driving oscillation of the attachment. The main body further comprises the lighting module 30 previously referred to, comprising a plurality of light sources. Components inside box 62 are components comprised by the attachment 16, including in particular the stem part of the toothbrush head.

The concept is applicable to a wide range of different personal care devices. One advantageous field of application is that of oral care devices. By way of non-limiting example, suitable applications include use within: a powered toothbrush, a powered flossing device using fluid jets, a tooth whitening device, or any oral optical treatment device. The concept might also be applied in other personal care devices, such as powered shavers, hairdryers, optical skin treatment devices, and many others.

As discussed above, embodiments make use of a controller. The controller can be implemented in numerous ways, with software and/or hardware, to perform the various functions required. A processor is one example of a controller which employs one or more microprocessors that may be programmed using software (e.g., microcode) to perform the required functions. A controller may however be implemented with or without employing a processor, and also may be implemented as a combination of dedicated hardware to perform some functions and a processor (e.g., one or more programmed microprocessors and associated circuitry) to perform other functions.

Examples of controller components that may be employed in various embodiments of the present disclosure include, but are not limited to, conventional microprocessors, application specific integrated circuits (ASICs), and field-programmable gate arrays (FPGAs).

In various implementations, a processor or controller may be associated with one or more storage media such as volatile and non-volatile computer memory such as RAM, PROM, EPROM, and EEPROM. The storage media may be encoded with one or more programs that, when executed on one or more processors and/or controllers, perform the required functions. Various storage media may be fixed within a processor or controller or may be transportable, such that the one or more programs stored thereon can be loaded into a processor or controller.

Variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality. A single processor or other unit may fulfill the functions of several items recited in the claims.

The mere fact that certain measures are recited in mutually different dependent claims does not indicate that a combination of these measures cannot be used to advantage.

A computer program may be stored/distributed on a suitable medium, such as an optical storage medium or a solid-state medium supplied together with or as part of other hardware, but may also be distributed in other forms, such as via the Internet or other wired or wireless telecommunication systems.

If the term “adapted to” is used in the claims or description, it is noted the term “adapted to” is intended to be equivalent to the term “configured to”. Any reference signs in the claims should not be construed as limiting the scope.

1. A personal care device comprising:
a main device body, comprising a plurality of light sources and a controller for controlling the light sources; and
an attachment adapted to releasably couple to the main device body, wherein the attachment comprises:
an attachment body;
a plurality of light patterning portions integral with the attachment body, each light patterning portion arranged to receive light from at least one light input area of the body, and to provide a respective 3D illumination pattern within the attachment body when the respective light input area is illuminated, each light patterning portion being optically supplied by a different respective light input area;
wherein at least a portion of the attachment body is formed of a light transmissible material, to permit each 3D illumination pattern to be visible to an observer at an exterior surface of the attachment body;
wherein the main device body comprises a respective light source for each of the light input areas of the attachment, each light source arranged to optically interface with a respective light input area when the attachment is coupled to the main device body, and each light source being individually controllable by the controller;
wherein the controller is adapted to implement a lighting scheme comprising dynamically controlling the light sources to produce a dynamically varying overall 3D illumination pattern within the attachment body.

2. The device of claim 1, wherein the lighting scheme comprises dynamically varying a selection of the light sources which is illuminated, so as to produce a dynamically varying overall 3D illumination pattern in the attachment body.

3. The device of claim 1, wherein the attachment comprises at least three light patterning portions, and wherein the respective 3D illumination patterns produced by the light patterning portions, when illuminated, are spaced from one another within the attachment body along at least a first dimension.

4. The device of claim 3, wherein the controller is adapted to control the light sources so as to sequentially illuminate the light patterning portions, in order, along the at least first dimension, to thereby provide a sequentially progressing illumination pattern in the attachment body.

5. The device of claim 3, wherein the each respective light patterning portion is adapted to produce a respective 3D illumination pattern comprising a plurality of discrete illumination nodes, spaced from one another in at least a second dimension.

6. The device of claim 5, wherein the first dimension is perpendicular to the second dimension, and wherein the illumination nodes of neighboring illumination patterns are spaced from one another in both the first and second dimensions in such a way that the illumination nodes of the plurality of illumination patterns together define a set of diagonal rows, the diagonal rows spaced from one another along the second dimension.

7. The device of claim 3, wherein the attachment has a proximal end, for coupling to the main device body, and a distal end, and wherein a second extension dimension of the attachment extends from the proximal end to the distal end, and wherein a first extension dimension extends perpendicular to the second dimension.

8. The device of claim 1, wherein the device is adapted to perform an optical treatment function in which treatment light is emitted from at least one light output area of the attachment.

9. The device of claim 1, wherein the light patterning portion comprises an optical structure with a 3D shape, and which is adapted to scatter, deflect or reflect light which is incident upon it.

10. The device of claim 1, wherein the light patterning portions comprise a sub-surface material patterning in the body of the attachment having a 3D shape which, when illuminated, creates an illumination pattern which matches said 3D shape.

11. The device of claim 10, wherein the light patterning portions comprise a 3D laser engraved pattern formed within the attachment body.

12. The device of claim 1, wherein the device is an oral care device.

13. The device of claim 1, wherein the device is powered toothbrush, and wherein the attachment is a brush head.
